(19) United States
(12) Patent Application Publication
(10) Pub. No.: US 2015/0087426 A1
(43) Pub. Date: Mar. 26, 2015

(54) MULTIPLAYER TASK GAME

(71) Applicants: Egan Schulz, San Jose, CA (US); Michelle Serrano, San Jose, CA (US); Laura Ward, San Jose, CA (US)

(72) Inventors: Egan Schulz, San Jose, CA (US); Michelle Serrano, San Jose, CA (US); Laura Ward, San Jose, CA (US)

(21) Appl. No.: 14/037,172

(22) Filed: Sep. 25, 2013

(51) Int. Cl. A63F 13/00

(52) U.S. Cl. CPC A63F 13/00
USPC 463/43

(57) ABSTRACT

There are responsible and irresponsible people in this world. Irresponsible or unreliable individuals often refuse to perform tasks because it is inconvenient, or they find no benefit to completing the task. Methods and systems that provide incentives and rewards to motivate these types of individuals to complete a task are described. In a game that supports multiple players, an administrator and players are designated. The administrator provides a list of tasks to the players. The players complete the tasks and indicate that the tasks are completed. The administrator provides a real-world reward, such as money, for completing the tasks. The reward is then deposited into the players' accounts.

### BACKGROUND

1. Field of the Invention

The present invention generally relates to task management, and more specifically, to systems and methods for motivating individuals to complete tasks.

2. Related Art

There are generally two types of people in this world—those who are responsible and those who are not. Often, it is difficult to get an irresponsible person to complete a task in a diligent, satisfactory, and timely manner. Irresponsible or unreliable individuals may not be motivated to complete a task, may be bored by a task, or may find no benefit to completing a task. Thus, a need exists for systems and methods that provide incentives and rewards to motivate an individual to complete a task.

### BRIEF DESCRIPTION OF THE FIGURES

FIG. 1 is a block diagram illustrating a system for managing and completing tasks according to an embodiment of the present disclosure;

FIGS. 2A-2K are screenshots of administrator and player interfaces according to an embodiment of the present disclosure.

FIG. 3 is a flowchart showing a method of managing and completing tasks according to an embodiment of the present disclosure; and

FIG. 4 is a block diagram of a system for implementing one or more components in FIG. 1 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The methods and systems described herein facilitate setting up a game to motivate individuals to achieve certain assigned tasks. The game encourages and rewards good behavior. A list of assigned tasks or actions is provided to the player, with each of the assigned tasks or actions having an assigned value. In various embodiments, a player can self-assign tasks or goals, and reward himself or herself.

The described methods and systems can be used to manage and complete tasks by providing goals and rewards. In a game that supports multiple users, one or more people may be designated as an administrator and one or more people may be designated as users or players. The administrator may provide a checklist of tasks or actions, and send these tasks to be completed to those whom the administrator designates as players. The players may then complete the actions or tasks and indicate that they are completed. The administrator provides a real-world reward, such as money, for completing all of the tasks, or for each task individually. When a task (or all tasks) are completed, the reward is deposited in the player's account. The reward may be money, gift cards, or the like. In various embodiments, the tasks include household chores, school assignments, actions for a mentee assigned by a mentor, paying bills, transferring money, adding to a savings account, and the like. The game may also be used to barter skills between the administrator and players, such that if one person with a particular skill needs a task to be completed, he or she can request that it be done in exchange for a particular skill he or she has.

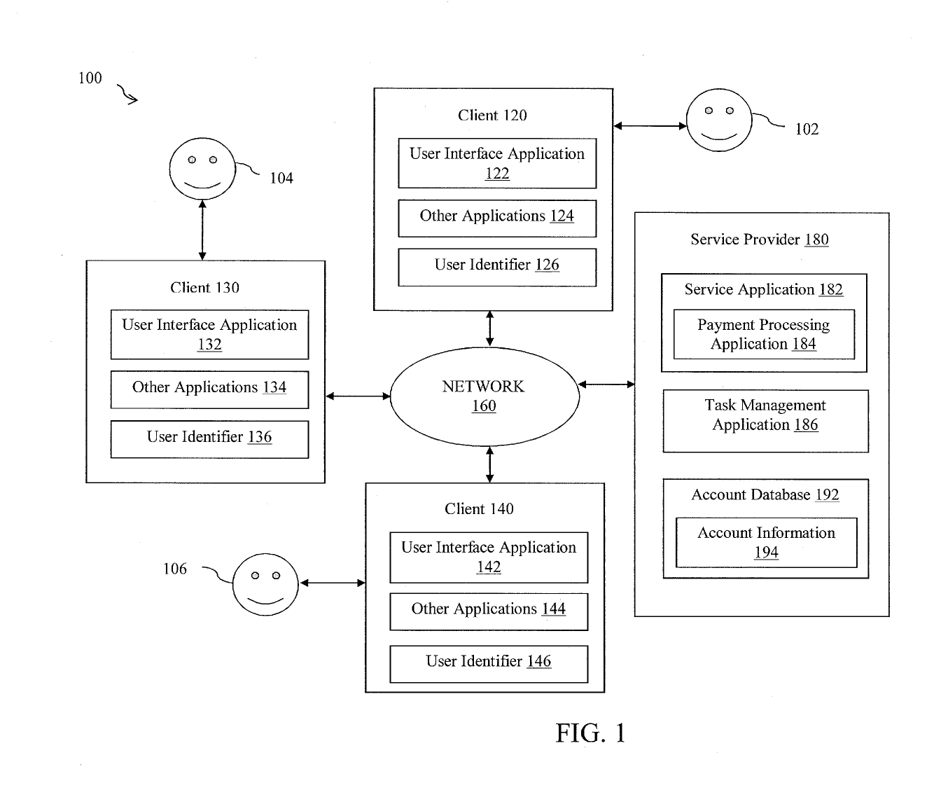

FIG. 1 shows one embodiment of a block diagram of a network-based system 100 adapted to manage and complete tasks. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes first client device 120 (e.g., network computing device), second client device 130, third client device 140, and at least one service provider server or device 180 (e.g., network server device) in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, first client device 120, second client device 130, third client device 140, and service provider server or device 180 may be associated with a particular link (e.g., a link, such as a URL (Uniform Resource Locator) to an IP (Internet Protocol) address).

The first client device 120, second client device 130, and third client device 140 in various embodiments, may be implemented using any appropriate combination of hardware and/or software configured for wired and/or wireless communication over the network 160. In various examples, first client device 120 may be implemented as a wireless telephone (e.g., cellular or mobile phone), a tablet, a personal digital assistant (PDA), a personal computer, a notebook computer, and/or various other generally known types of wired and/or wireless computing devices. It should be appreciated that first client device 120 may be referred to as a user device or a customer device without departing from the scope of the present disclosure.

The first client device 120, in one embodiment, includes a user interface application 122, which may be utilized by the administrator 102 to conduct transactions (e.g., shopping, purchasing, bidding, transferring, etc.) with the service provider server 180 and/or assign tasks or actions to players 104 and/or 106 over the network 160. In one aspect, funds may be directly and/or automatically debited from an account related to the administrator 102 via the user interface application 122 and deposited into an account associated with player 104 and/or 106.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

The first client device 120, in various embodiments, may include other applications 124 as may be desired in one or more embodiments of the present disclosure to provide additional features available to administrator 102. In one example, such other applications 124 may include security applications for implementing client-side security features, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

The first client device 120, in one embodiment, may include at least one user identifier 126, which may be implemented, for example, as operating system registry entries, cookies associated with the user interface application 122, identifiers associated with hardware of the first client device 120, or various other appropriate identifiers. The user identifier 126 may include one or more attributes related to the administrator 102, such as personal information related to the administrator 102 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the administrator 102 with a particular user account maintained by the service provider server 180.

Second client device 130 and third client device 140 may have similar applications and modules as first client device 120, but are used, in this example, for receiving tasks or actions, real-world rewards, texts, and other communications sent by administrator 102 via the first client device 120 via the service provider server 180. Second client device 130 and third client device 140 may also include a user interface application 132, 142 and one or more other applications 134, 144 which may be used, for example, to provide a convenient interface to permit player 104 or player 106 to browse information and view assigned tasks over network 160. For example, in one embodiment, user interface application 132, 142 may be implemented as a web browser configured to view information available over the Internet and communicate with service provider server 180 to receive and send information regarding assigned tasks or actions to administrator 102.

Second client device 130 and third client device 140 may further include other applications 134, 144 such as security applications for implementing client-side security features, programmatic client applications for interfacing with appropriate application programming interfaces (APIs) over network 160, or other types of applications. Applications 134, 144 may also include email, text, IM, and voice applications that allow player 104 or player 106 to communicate through network 160, receive messages from administrator 102, and create and manage funding sources. Second client device 130 and third client device 140 includes one or more user identifiers 136, 146 which may be implemented, for example, as operating system registry entries, cookies associated with user interface application 132, 142, identifiers associated with hardware of second client device 130 or third client device 140, or other appropriate identifiers, such as used for payment/recipient/device authentication, e.g., the phone number associated with second client device 130 or third client device 140. Identifiers may be used by a service provider to associate player 104 or player 106 with a particular account maintained by the service provider.

The client devices 120, 130, and 140 can communicate with the service provider server 180 to receive webpages, messages, and transmit and receive data. In a similar fashion, service provider server 180 can communicate data and other information to client devices 120, 130, and 140.

The service provider server 180, in one embodiment, may be maintained by a transaction processing entity, which may provide processing for financial transactions and/or information transactions between the administrator 102 and players 104 and 106. As such, the service provider server 180 includes a service application 182, which may be adapted to interact with each client device 120, 130, and/or 140 over the network 160 to facilitate the managing and assigning of tasks by the administrator 102 to the players 104 and/or 106. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing module 184 to process purchases and/or payments for financial transactions between the administrator 102, player 104, and player 106. In one implementation, the payment processing module 184 assists with resolving financial transactions through validation, delivery, and settlement. As such, the service application 182 in conjunction with the payment processing module 184 settles indebtedness between the administrator 102, player 104, and player 106, wherein accounts may be directly and/or automatically debited and/or credited of monetary funds in a manner as accepted by the banking industry.

The service provider server 180, in one embodiment, may be configured to maintain one or more user accounts and merchant accounts in an account database 192, each of which may include account information 194 associated with one or more individual users (e.g., administrator 102 and players 104 and 106). For example, account information 194 may include private financial information of each user 102, 104, and 106, such as one or more account numbers, passwords, credit card information, banking information, or other types of financial information, which may be used to facilitate financial transactions between administrator 102 and players 104 and 106. In various aspects, the methods and systems described herein may be modified to accommodate users that may or may not be associated with at least one existing user account.

In one implementation, the administrator 102 and/or players 104 and 106 may have identity attributes stored with the service provider server 180, and administrator 102 and/or players 104 and 106 may have credentials to authenticate or verify identity with the service provider server 180. User attributes may include personal information, banking information and/or funding sources as previously described. In various aspects, the user attributes may be passed to the service provider server 180 as part of a login, search, selection, purchase, and/or payment request, and the user attributes may be utilized by the service provider server 180 to associate administrator 102 and/or players 104 and 106 with one or more particular user accounts maintained by the service provider server 180.

The service provider server 180 also includes task management application 186. The application 186 manages and assigns tasks according to directions received by the administrator 102. The task management application 186 provides details of the task game. The details may include the name of the administrator 102, names of the players 104 and 106, the tasks assigned by the administrator 102 to the players 104 and/or 106, the real-world reward associated with the completion of each assigned task, a time limit for completion of each assigned task, percentage of assigned tasks completed, etc.

In one embodiment, the task management application 186 displays player specific achievement data. The achievement data includes a list of assigned tasks and completion status of the tasks. Each assigned task can include a completion icon if the task is completed by the player or progress information (e.g., 25% complete) that indicates an amount of completion.

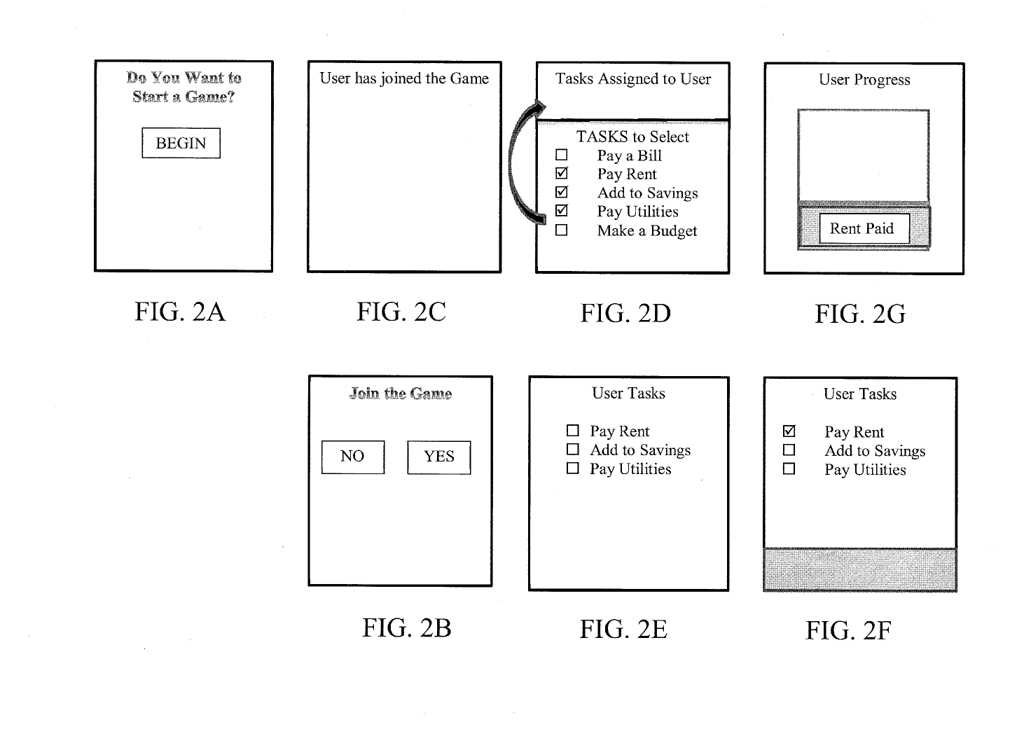

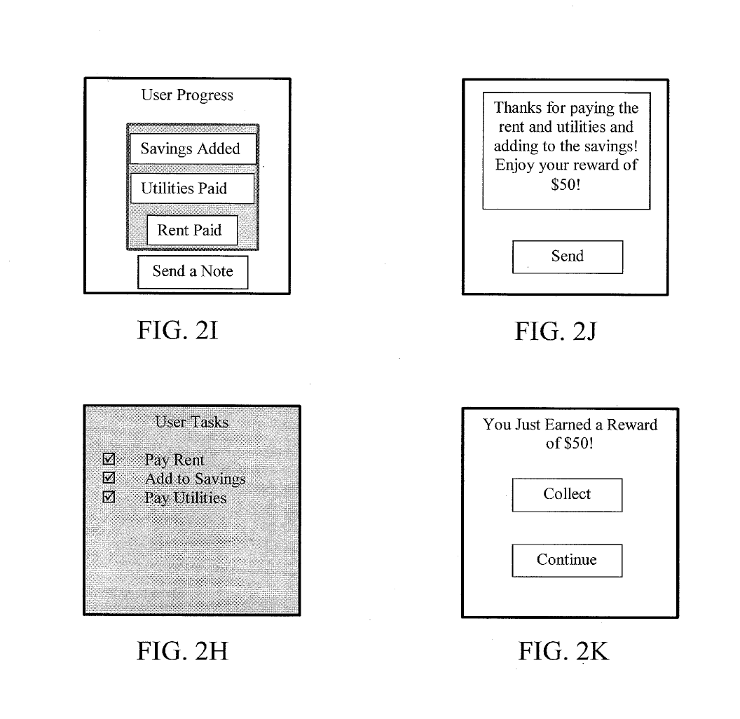

Turning now to FIGS. 2A-2K, illustrated are game interfaces that may be rendered on the client devices 120, 130, and 140. The game interfaces may be automatically generated and presented to the user in response to the user visiting or accessing the service provider server's website or a third party website. The game interface is configured to receive signals from the user. For example, the user can click on the game interface, or enter commands from a keyboard or other suitable input device. The game interface can display various game components, such as the game environment, options available to the player, game results, etc. The user can click, touch, or otherwise interact with various icons in the game interface to activate various game options.

FIG. 2A illustrates the game interface shown to administrator 102, asking if administrator 102 wants to start a game. The administrator 102 presses the begin button to start the game, and designates who he or she wants to join the game, e.g., player 104 and/or player 106. FIG. 2B illustrates the game interface that player 104 and/or player 106 sees. When a player presses “YES,” the interface in FIG. 2C is shown to administrator 102 to inform administrator 102 that the player has joined the game. At FIG. 2D, administrator 102 is prompted to select tasks to assign to the player. For example, as shown, administrator 102 has assigned paying rent, adding to savings, and paying utilities to the player. Once the tasks are checked, the task is moved to the top of the screen. In another embodiment, the tasks are dragged and dropped from a library of tasks. The administrator 102 may then designate an appropriate real-world reward to motivate the player to complete the list of assigned tasks.

At FIG. 2E, the player 104 and/or 106 sees the tasks assigned to him or her. As the player completes a task, he or she checks them off his or her list. This is shown in the screenshot of FIG. 2F. FIG. 2F also shows player progress in completing the assigned tasks by partially shading the page. In various embodiments, if one or all of the tasks are completed using the service provider, each task is automatically checked off the list of the player. The administrator 102 sees the interface shown on FIG. 2G, which notes a completed task and player progress in completing the list of tasks. As shown, player progress is noted by shading a portion of the rectangle to show the fraction of the tasks completed.

At FIG. 2H, the player completes all the tasks on his or her list, and the page is completely shaded to show achievement of all the tasks. The administrator 102 sees the interface on FIG. 2I, which shows the rectangle completely filled to indicate that the tasks are 100% complete. The administrator 102 is asked if he or she wants to send a note, and in FIG. 2J, a note stating that the tasks are completed and the designated real-world reward can be sent. The administrator 102 pushes send, and the player sees the interface in FIG. 2K, letting him or her know that he or she earned a reward. The player can collect the reward, or choose to continue to retrieve another set of assigned tasks.

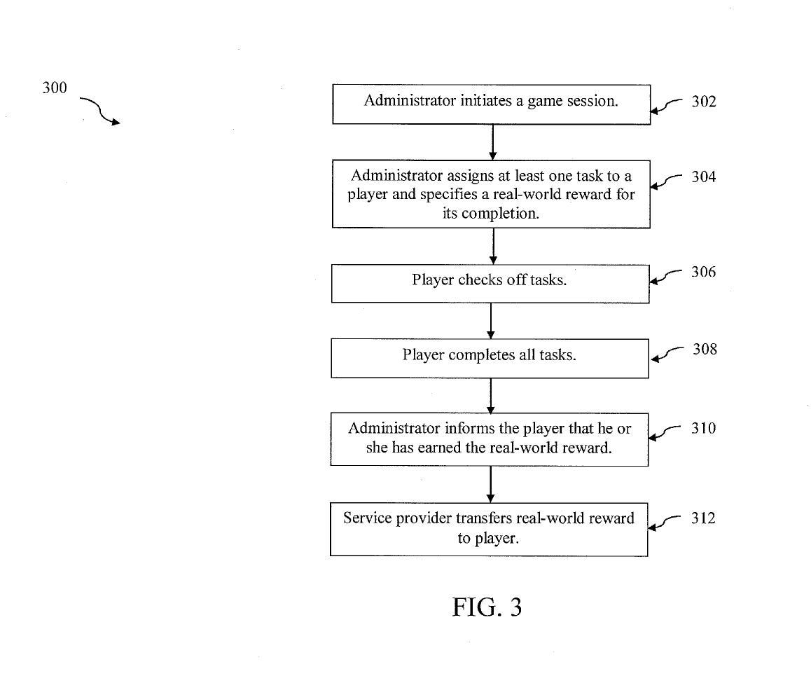

Referring now to FIG. 3, a flowchart of a method 300 for managing and assigning tasks is illustrated according to an embodiment of the present disclosure. In an embodiment, at step 302, administrator 102 accesses a service provider site or mobile app via the client device 120, and initiates a game session. The administrator 102 may select a player from a friends list or enter the name of a player (e.g., player 104 or player 106). An administrator may be a parent, grandparent, guardian, teacher, employer, spouse, partner, roommate, or the like. The player may be a child, minor, student, sibling, employee, spouse, partner, roommate, or the like. In one embodiment, the administrator and players are all adults. The administrator 102 may determine age, gender, or other requirements for the players.

At step 304, the administrator 102 assigns at least one task to a player (e.g., player 104 or player 106) and designates a real-world reward for its completion. Examples of tasks include a chore, a behavior, a health-related task, a study-related task, reading books, doing homework, studying, practicing an instrument, sport, or extracurricular activity, eating vegetables and fruits, exercising, brushing one's teeth, combing one's hair, completing an assignment, making a new friend, making a new business contact, giving a speech, cleaning, taking out the trash, doing the laundry, paying the rent, purchasing a gift, transferring money, buying groceries, adding to savings, sending money, paying bills, and the like. In an embodiment, the method may include categorizing an assigned task by a category. For example, the categories can include kitchen chores, bathroom chores, bedroom chores, bill payment, grocery shopping, gift giving, and the like.

A user interface for administrators may include a To Do Chart Facility. The To Do Chart Facility may be used by the administrator 102 to create or edit to do lists, assign rewards commensurate with task completion, and/or assign a time for the task to be completed. From an Add Tasks page, administrators may choose to create a custom task or browse a list of recommended task categories and select multiple tasks. In some embodiments, the administrator may select a task using crowdsourcing. For example, a list of tasks or actions that are shared publicly on a forum may be available for the administrator to browse and select. Such a list may be labeled “trending tasks,” and the administrator is able to view and select categories of tasks that other people have submitted. When adding a task, the administrator 102 may assign a time schedule for the task by using a scheduling drop down menu. The drop down menu may contain: Everyday, Weekday, Weekends, On time, No due time, One time, Due on [insert date], On these days . . . , and the like.

In various embodiments, the administrator 102 assigns more than just one task to a player, and specifies a reward for each completed task, or a reward for completing all the tasks. In some embodiments, the screen is prepopulated with default types of tasks in a library, which can be dragged and dropped to be assigned to the player. In other embodiments, the administrator 102 types in the tasks manually. Once the list is complete, the player can see what tasks he or she needs to accomplish to earn the reward.

A “real-world reward” is a tangible reward outside of the game situation. Examples of real-world rewards include food, drinks, money, coupons, gift cards, vouchers, gift certificates, and the like. It should be noted that the rewards are merely exemplary of a multitude of rewards that can be provided as an incentive to complete tasks in accordance with the present disclosure. The administrator 102 may select an icon associated with the reward.

In some embodiments, the administrator 102 may consult with the players playing the game to select the reward to encourage their participation and enthusiasm for the game. The rewards are arranged to be acquired by the players in response to completing an assigned task.

Tasks can be added or deleted as desired and the rewards earned by completion of the tasks can also be established or adjusted to tailor the game to different players. In various embodiments, the method may include providing a level meter associated with the tasks for indicating the status of task completion. In some embodiments, the administrator 102 may penalize the player for failing to complete the task, late completion of a task, or a poorly completed task. For example, the administrator 102 may require the player to pay the administrator 102 a certain amount of money.

In various embodiments, the player assigned a task (e.g., player 104) is unable to complete the task because he or she is too busy and just does not have the time. In this case, player 104 may advertise to other players in the game (e.g., player 106) that he or she needs assistance in completing a task. If player 106 decides to take the task and completes the task, player 104 can transfer the reward to player 106. Alternatively, player 104 can inform administrator 102 that the task was handed over to player 106 so that the administrator 102 can have the reward transferred directly to player 106. The service provider server may also be informed that the tasks are accomplished, and the reward can automatically be sent based on recognition that the task is completed.

In different embodiments, one or more players (e.g., players 104 and 106) can take the role of an administrator from within the game session initiated by administrator 102. In that sense, a player can then initiate a game session within the game session and assign tasks to players within this “sub-game.” The “sub-game” can have the same characteristics as discussed above with respect to the game initiated from administrator 102. For example, if player 104 has a relatively large task that can be broken up into smaller tasks, player 104 may create a “sub-game” and assign these smaller tasks to other players. The reward total to the other players may be less than the reward to player 104 for completing the task, such that the work in initiating a new game is financially beneficial to player 104. This can be extended so that there are games within games within games, etc. In other embodiments, administrator 102 or “sub-administrators” may limit or prohibit games within the game.

For example, player 104 may have been assigned the tasks of buying groceries, paying the electricity bill, and buying a gift for a party, and the reward for completion of all the tasks is set at $100. Player 104 can take these three tasks and assign them to other players in the game (e.g., player 106), with a reward of $80 spread out for the three tasks. Player 104 thus still receives a reward of $20.

At step 306, the player checks off tasks as he or she completes them. In an exemplary embodiment, the administrator 102 can check the player's progress, and the progress is shown graphically to the administrator 102 and the player. At step 308, the player completes all the tasks assigned. The service provider server 180 is informed that the tasks are accomplished, and sends a message to the administrator 102.

At step 310, the administrator 102 informs the player that he or she has earned a real-world reward, and the administrator 102 instructs the service provider to transfer the designated reward to the player. At step 312, the service provider transfers the real-world reward from an account of the administrator 102 to an account of the player. In some embodiments, the transfer of the reward is automatic once the service provider is informed that the tasks have been completed.

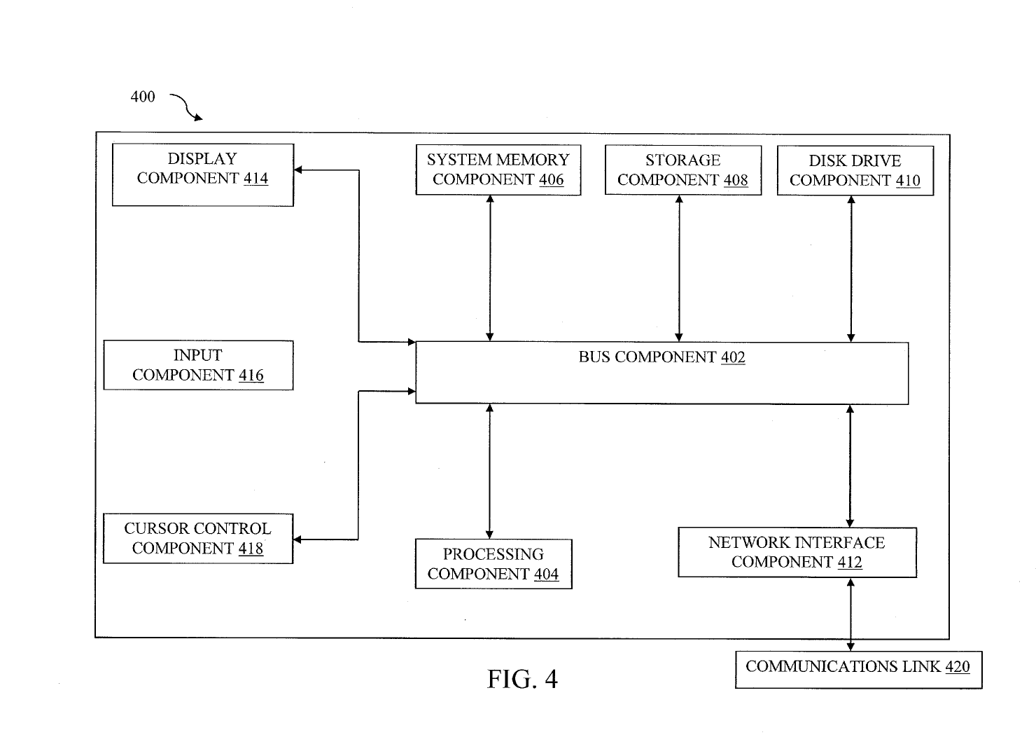

Referring now to FIG. 4, a block diagram of a system 400 is illustrated suitable for implementing embodiments of the present disclosure, including client devices 120, 130, and 140, and service provider server or device 180. System 400, such as part of a cell phone, a tablet, a personal computer and/or a network server, includes a bus 402 or other communication mechanism for communicating information, which interconnects subsystems and components, including one or more of a processing component 404 (e.g., processor, micro-controller, digital signal processor (DSP), etc.), a system memory component 406 (e.g., RAM), a static storage component 408 (e.g., ROM), a network interface component 412, a display component 414 (or alternatively, an interface to an external display), an input component 416 (e.g., keypad or keyboard), and a cursor control component 418 (e.g., a mouse pad).

In accordance with embodiments of the present disclosure, system 400 performs specific operations by processor 404 executing one or more sequences of one or more instructions contained in system memory component 406. Such instructions may be read into system memory component 406 from another computer readable medium, such as static storage component 408. These may include instructions to process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 404 for execution. Such a medium may take many forms, including but not limited to, non-volatile media, volatile media, and transmission media. In various implementations, volatile media includes dynamic memory, such as system memory component 406, and transmission media includes coaxial cables, copper wire, and fiber optics, including wires that comprise bus 402. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 400. In various other embodiments, a plurality of systems 400 coupled by communication link 420 (e.g., network 160 of FIG. 1, LAN, WLAN, PTSN, or various other wired or wireless networks) may perform instruction sequences to practice the disclosure in coordination with one another. Computer system 400 may transmit and receive messages, data, information and instructions, including one or more programs (i.e., application code) through communication link 420 and communication interface 412. Received program code may be executed by processor 404 as received and/or stored in disk drive component 410 or some other non-volatile storage component for execution.

In view of the present disclosure, it will be appreciated that various methods and systems have been described according to one or more embodiments for managing and completing tasks.

Although various components and steps have been described herein as being associated with client device 120, 130, and 140, and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory device storing administrator account and player account information; and
one or more processors in communication with the memory device and operable to:
receive an assignment of at least one task to a player from an administrator;
associate the at least one task with a real-world reward;
receive an indication that the at least one task is completed; and
transfer the real-world reward to the player.

2. The system of claim 1, wherein the player and administrator are both adults, and are roommates, spouses, partners, or a combination thereof.

3. The system of claim 1, wherein the real-world reward comprises money, gift cards, coupons, or a combination thereof.

4. The system of claim 1, wherein a plurality of tasks are assigned to the player and the one or more processors is further operable to display progress of completion of individual tasks.

5. The system of claim 1, wherein the real-world reward is transferred from an administrator account to a player account.

6. The system of claim 1, wherein the one or more processors is further operable to notify other players that the player cannot complete an assigned task, re-assign the task to one other player, and transfer the real-world reward to the other player when the assigned task is completed.

7. The system of claim 1, wherein the one or more processors is further operable to receive an assignment of the at least one task from the player to one other player and transfer a portion of the real-world reward to the other player when the at least one task is completed.

8. A method of managing and completing tasks, comprising:
receiving, by one or more hardware processors of a service provider, an assignment of at least one task to a player from an administrator;
associating the at least one task with a real-world reward;
receiving an indication that the at least one task is completed; and
transferring the real-world reward to the player.

9. The method of claim 8, wherein the player and administrator are both adults, and are roommates, spouses, partners, or a combination thereof.

10. The method of claim 8, wherein the real-world reward comprises money, gift cards, coupons, or a combination thereof.

11. The method of claim 8, wherein a plurality of tasks are assigned to the player and further comprising displaying progress of completion of individual tasks.

12. The method of claim 8, wherein the real-world reward is transferred from an administrator account to a player account.

13. The method of claim 8, further comprising notifying other players that the player cannot complete the assigned task, re-assigning the task to one other player, and transferring the real-world reward to the other player when the assigned task is completed.

14. The method of claim 8, further comprising receiving an assignment of the at least one task from the player to one other player and transferring a portion of the real-world reward to the other player when the at least one task is completed.

15. A non-transitory machine-readable medium comprising a plurality of machine-readable instructions which, when executed by one or more processors, are adapted to cause the one or more processors to perform a method comprising:
receiving an assignment of at least one task to a user from an administrator;
associating the at least one task with a real-world reward;
receiving an indication that the at least one task is completed; and
transferring the real-world reward to the user.

16. The non-transitory machine-readable medium of claim 15, wherein the player and administrator are both adults, and are roommates, spouses, partners, or a combination thereof.

17. The non-transitory machine-readable medium of claim 15, wherein a plurality of tasks are assigned to the player and the method further comprises displaying progress of completion of individual tasks.

18. The non-transitory machine-readable medium of claim 15, wherein the real-world reward is transferred from an administrator account to a player account.

19. The non-transitory machine-readable medium of claim 15, wherein the method further comprises notifying other players that the player cannot complete the assigned task, re-assigning the task to one other player, and transferring the real-world reward to the other player when the assigned task is completed.

20. The non-transitory machine-readable medium of claim 15, wherein the method further comprises receiving an assignment of the at least one task from the player to one other player and transferring a portion of the real-world reward to the other player when the at least one task is completed.
